(19) United States
(12) Patent Application Publication
(10) Pub. No.: US 2015/0254743 A1
(43) Pub. Date: Sep. 10, 2015

(54) SYSTEM AND METHOD FOR ARRANGING THE SALE, SERVICE, DELIVERY AND/OR TRANSPORTATION OF RECREATIONAL MARIJUANA

(71) Applicant: DEIRDRE DELLAPORTAS, Chicago, IL (US)

(72) Inventor: DEIRDRE DELLAPORTAS, Chicago, IL (US)

(21) Appl. No.: 14/310,869

(22) Filed: Jun. 20, 2014

Related U.S. Application Data
(60) Provisional application No. 61/948,367, filed on Mar. 5, 2014.

(51) Int. Cl. G06Q 30/06; G06Q 50/26

(52) U.S. Cl. CPC G06Q 30/0607; G06Q 50/265

(57) ABSTRACT

Embodiments of the invention relate to a system and method for arranging for the sale, service, delivery and/or transportation of recreational marijuana and marijuana products over a network. The method includes arranging for the sale, service, delivery and/or transportation of recreational marijuana and marijuana products over a network, including receiving an individual's personal information transmitted over the network from a user device; receiving an individual's location; verifying the individual is in a state which allows the sale, service, delivery and/or transportation of recreational marijuana and marijuana products based on such location; determining the individual is legally qualified to purchase recreational marijuana and marijuana products based at least on the received personal information; and authorizing the sale of the recreational marijuana and marijuana products to the individual.

### CLAIM FOR PRIORITY

The invention claim the benefit of, and priority to, U.S. Provisional Application Ser. No. 61/948,367 filed Mar. 5, 2014, the complete subject matter of which is incorporated herein by reference.

### FIELD OF THE INVENTION

The invention relates to a system and method for arranging for the sale, service, delivery and/or transportation of recreational marijuana and marijuana products over a network.

### BACKGROUND OF THE INVENTION

Scientists continue to uncover physical and psychological benefits of cannabis, commonly known as marijuana. However, states and counties regulate the advertising, purchase, sale, possession and/or usage of marijuana in specified quantities and for specified purposes. However, due to its regulated nature, the dissemination of marijuana needs to be limited to only those individuals legally authorized to receive it to prevent access by those individuals not allowed to make purchase.

Accordingly, it is an object of the present invention to provide a system and method for arranging for the sale of recreational marijuana and marijuana products over a network.

These and other objects will be readily evident upon a study of the specification and the accompanying drawing wherein:

### SUMMARY OF THE INVENTION

Embodiments of the invention relate to a system and method for arranging for the sale, service, delivery and/or transportation of recreational marijuana and marijuana products over a network. The method includes arranging for the sale of recreational marijuana and marijuana products over a network, including receiving an individual's personal information transmitted over the network from a user device; receiving an individual's location; verifying the individual is in a state which allows the sale of recreational marijuana and marijuana products based on such location; determining the individual is legally qualified to purchase recreational marijuana and marijuana products based at least on the received personal information; and authorizing the sale, service, delivery and/or transportation of the recreational marijuana and marijuana products to the individual.

Another embodiment relates to a computer-readable storage medium operable on storage medium and having stored there on computer-executable instructions that, in response to execution, cause a data transmission system to execute a method. In this embodiment, the method includes receiving an individual's personal information transmitted over the network from a user device; receiving an individual's location; verifying the individual is in a state which allows the sale of recreational marijuana and marijuana products based on such location; determining the individual is legally qualified to purchase recreational marijuana and marijuana products based at least on the received personal information; and authorizing the sale, service, delivery and/or transportation of the recreational marijuana and marijuana products to the individual.

Still another embodiment relates to a system for arranging for the sale of recreational marijuana and marijuana products. The system comprises at least one server having computer-executable instructions thereon that, in response to execution, cause execution of a method; at least one user device having a downloadable application (or otherwise accessible or loadable) operating thereon; and at least one network enabling communication between the at least one processing unit and the at least one user device. The system performs the method of determining an individual's location using the user device; transmitting an individual's personal information and location over the network from the user device; receiving the individual's personal information and location at the at least one processor transmitted over the network; verifying the individual is in a state which allows the sale of recreational marijuana and marijuana products based on such location; determining the individual is legally qualified to purchase recreational marijuana and marijuana products based at least on the received personal information; and authorizing the sale of the recreational marijuana and marijuana products to the individual.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 depicts a block diagram illustrating a system for arranging the sale, service, delivery and/or transportation of recreational marijuana and marijuana products in accordance with one embodiment of the invention;

FIG. 2 depicts a block diagram illustrating another system for arranging the sale, service, delivery and/or transportation of recreational marijuana and marijuana products in accordance with another embodiment of the invention;

FIG. 3 depicts a flow chart illustrating a method for registering with the system for arranging the sale, service, delivery and/or transportation of recreational marijuana and marijuana products in accordance with one embodiment of the invention; and

FIG. 4 depicts a flow chart illustrating a method for arranging the sale, service, delivery and/or transportation of recreational marijuana and marijuana products in accordance with one embodiment of the invention.

Throughout the various figures, like reference numbers refer to like elements.

### DETAILED DESCRIPTION OF PRESENTLY PREFERRED EMBODIMENTS

Embodiments of the invention relate to a system and method for arranging the sale, service, delivery and/or transportation of recreational marijuana and marijuana products in accordance with one embodiment of the invention. It should be appreciated that the terms recreational marijuana and marijuana products include hash oil, goods made from marijuana, cartridges, smoking devices and the like. Embodiments of the system and method ensure that retail/providers do not inadvertently supply prohibited or unauthorized users such as users who are not legally permitted to purchase specific goods or services or users who the retailer/provider is not licensed or otherwise permitted to supply.

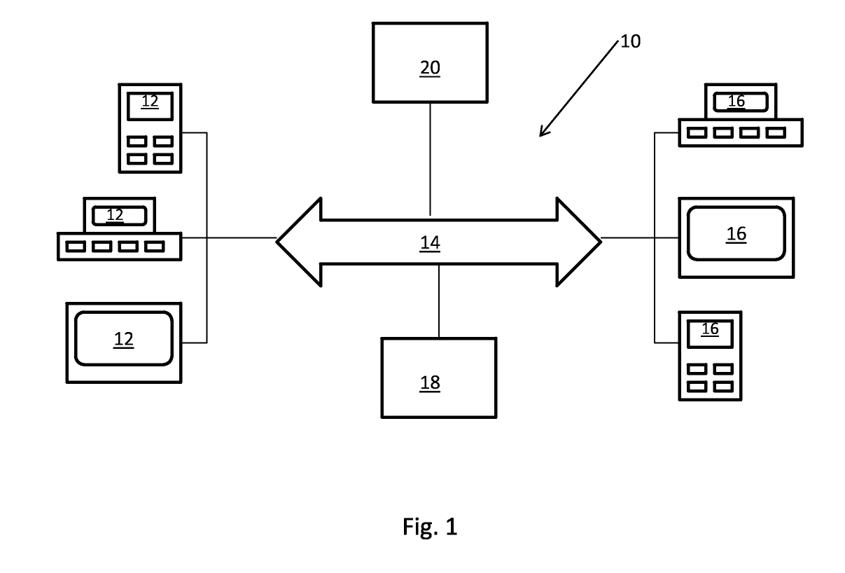

FIG. 1 depicts a block diagram illustrating a system, generally designated 10, for arranging the sale, service, delivery and/or transportation of recreational marijuana and marijuana products in accordance with one embodiment. As illustrated, system 10 includes a plurality of user devices 12 and retailer/provider devices 16 communicating (i.e., both transmitting and receiving) with a network 14.

In at least one embodiment, the user devices 12 and retail/provider devices 16 include cell phones, smart phones, tablets, laptops, notebook computers, personal digital assistants, work stations, desktop computers, land line or hard wired phones, personal computers, stand alone computers, tower computers, cash registers, POP device, smart card terminal, biometric scanner, cars, planes, trains, and the like which allow wired or wireless communication. Further, the network 14 includes any intranet, wired network, wireless network (Wi-Fi), satellite network, cellular network (3G, 4G, LTE) and the like. The user may access a website via the user device 12 or download an application to the user device 12.

FIG. 1 further illustrates a server device 16 communicating with the network 14. The server device includes processors, memory, databases including a non-transitory computer readable recoding medium and having stored there on computer-executable instructions that, in response to execution, execute a method adapted to receive an individual's personal information transmitted over the network from a user device; receive an individual's current or requested service location; verify the individual is in a state which allows the sale of recreational marijuana and marijuana products based on such location; determine the individual is legally qualified to purchase recreational marijuana and marijuana products based at least on the received personal information; and authorize the retailer/provider to make the sale of the recreational marijuana and marijuana products to the individual. The server may additionally provide information such that the retailer/provider may transport and deliver the information to the user based on the user's current location or other location as designated by the user. FIG. 1 further includes a delivery module 18 and/or a financial module 20 communicating with the network 14, enabling the user to pay for the purchase.

As provided above the location may be a geographic region specific to the user based on the user's current location or the user's requested service location (e.g., the pickup location for a transport service, or a delivery location). For example, in some cases, the current location can be different from the requested service location, so that the user can select a particular pickup location or delivery location that is different from the current location. The user's current location or service performance location can be determined by the location determination. In one example, the location determination can receive global positioning system (GPS) data from location-based/geo-aware resources of the user device 12. In addition, the location determination can also receive GPS data from other applications or programs that operate on the user device 12. For example, the system can communicate with one or more other applications using one or more application program interfaces (APIs). Alternatively, the user can input the location manually into the user device 12.

From the user's current or requested service location, the retailer/provider may identify an appropriate jurisdiction, such as a country or state, for the user. The retailer/provider may then apply the laws or other relevant rules of that jurisdiction to determine whether payment can be accepted and the sale made. For example, the retailer/provider may only be licensed to supply recreational marijuana and marijuana products to users located in certain countries or states. Accordingly, it may be illegal or prohibited to supply users in other jurisdictions.

Alternatively, the retailer/provider may be supplying goods or services which are illegal (or prohibited for other reasons) in certain states or countries. Accordingly, if the retailer/provider identifies that the user is located in one of these states or countries, they may refuse to supply the user. The jurisdiction of the user may also be used to perform one or more data verification checks which are based on the current location of the user. In particular, the retailer/provider may be supplying recreational marijuana and marijuana products that are age restricted in some or all states or countries.

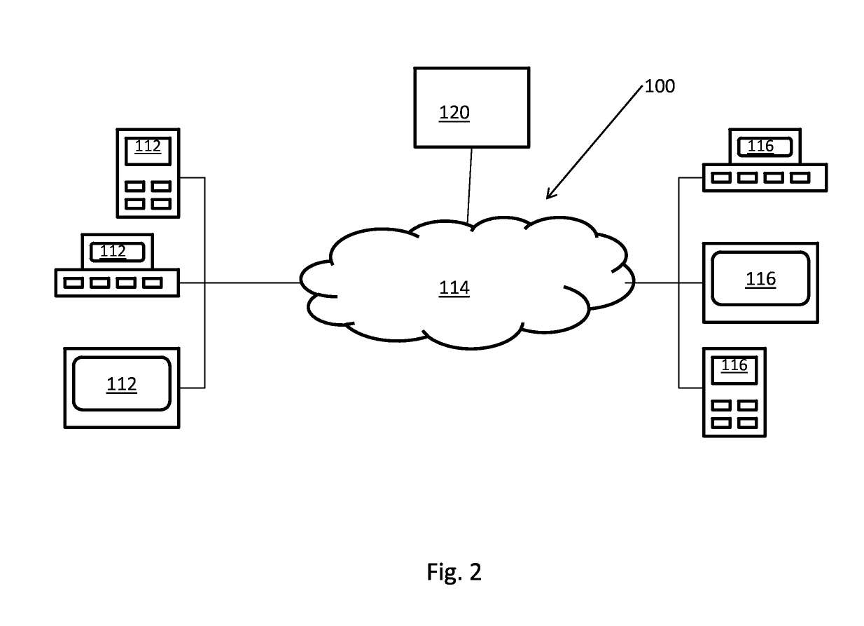

FIG. 2 depicts a block diagram illustrating a system, generally designated 100, for arranging the sale, service, delivery and/or transportation of recreational marijuana and marijuana products in accordance with one embodiment. As illustrated, system 100 includes a plurality of user devices 112 and retailer/provider devices 116 communicating with a cloud network 114. The user devices 112 and retail/provider devices 116 include cell phones, smart phones, tablets, laptops, notebook computers, personal digital assistants, work stations, desktop computers, land line or hard wired phones, personal computers, stand alone computers, tower computers, cash registers, POP device, smart card terminal, biometric scanner, cars, planes, trains, and the like which allow wired or wireless communication similar to that provided above.

In the illustrated embodiment, the cloud network 114 includes a plurality of cloud-based servers having supporting cloud hardware in communication with the user devices 112 and retailer/provider device 116. The cloud network is adapted to receive an individual's personal information transmitted over the network from a user device; receive an individual's location (determined by a GPS system, API or entered manually); verify the individual is in a state which allows the sale of recreational marijuana and marijuana products based on such location; determine the individual is legally qualified to purchase recreational marijuana and marijuana products based at least on the received personal information; and authorize the retailer/provider to make the sale of the recreational marijuana and marijuana products to the individual. The server may additionally provide information such that the retailer/provider may transport and deliver the information to the user based on the user's current location or other location as designated by the user.

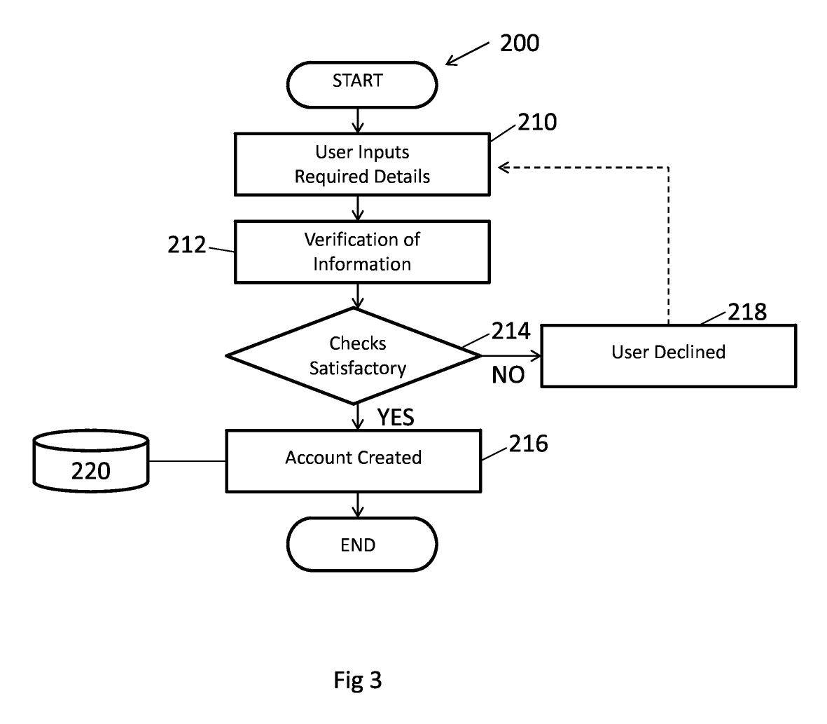

FIG. 2 further includes a financial module 120 communicating with the network 114, enabling the user to pay for the purchase. Embodiments are contemplated that do not include a financial mode, and the user only pays cash. To enable the user to purchase recreational marijuana and marijuana products, the user must register with the system. FIG. 3 illustrates a flowchart of a registration process, generally designated 200, which is performed between the user and the system. The user may again access a website via the user device 112 or downloads and installs a mobile application to the user device 112.

Once installed, the user accesses the website or opens the application on their user device and establishes a user account. Accordingly, the user inputs required details into the system to register with the system, block 210. These details may include their full name, email address, date of birth, telephone number, passport number, national security number, etc. The user may also be required to select a username and password which are used to access their account and thus provides security in case they were to lose their user device. The user may also be required to input their password when purchasing or redeeming an electronic voucher in order to provide another level of security.

As part of the registration process 200, the user may also be required to provide details of one or more payment cards which they wish to associate with the account. Accordingly, the user may be required to input details regarding the payment cards, such as the card number, start date, expiry date, name on card, card security code, etc. The user may also designate a bank account to which payments may be made (for example, in the case of gambling winnings). However, such financial information may be provided at a later date (i.e. prior to first purchase) and not required as part of the initial registration process.

Once the information has been provided by the user, it is submitted to the system. During this activation, the GPS function of the user's user devices determines the user's (i.e. user device) current position and transmits this information to the system. Alternatively, activation may be performed at a later date, for example, where the user is not at their registered address during registration.

The information is then verified by the system, block 212. As part of this verification check, the system verifies that the information has been validly entered (i.e. in the correct format). The system may also carry out a number of checks to confirm that the user is who they say they are. These checks may satisfy customer due diligence requirements, such as a “Know Your Customer” (KYC) check.

The verification checks may include confirming that the location of the user provided during activation by the GPS function of their user device corresponds to their registered address. If the user is not currently located at, or in close proximity, to their registered address, activation may not be possible. The system may also perform searches within electronic databases, such as the electoral role, to confirm that the user lives at the address provided.

If electronic verification is not sufficiently robust, the system may use traditional paper-based customer due diligence checks, such as a (KYC) check. This may include the user submitting a copy of a utility bill to the system to confirm their address.

Once the verification checks have been completed, the systems creates the user account, block 216 and sets the account as being live. The user is then able to fully access the functions of the application and to purchase electronic vouchers from the system.

On the other hand, if the verification checks are unsatisfactory, the system may decline the user and not create an account, block 218. As indicated by the dashed line in FIG. 3, the user may be provided with an opportunity to provide additional or replacement information which can form the basis for repeat verification checks.

In one embodiment, when activated, the system sends a confirmation message containing a personal identification number (PIN) to the user. The PIN may be sent to the user via an email or an SMS text message. The PIN may be used in order to access the application for the first time after activation. The user may be prompted to change the PIN when they first use the application. Alternatively, the PIN may only be required to first access the application and thereafter no longer needed.

When the user account is created, the system stores details of the account and the information provided by the user during the registration process in a user database, block 220. This includes the information provided for the completion of the customer due diligence checks and more general personal information of the user. This information may be retrieved at a later date and provided to the retailer/provider, as will be described in more detail below.

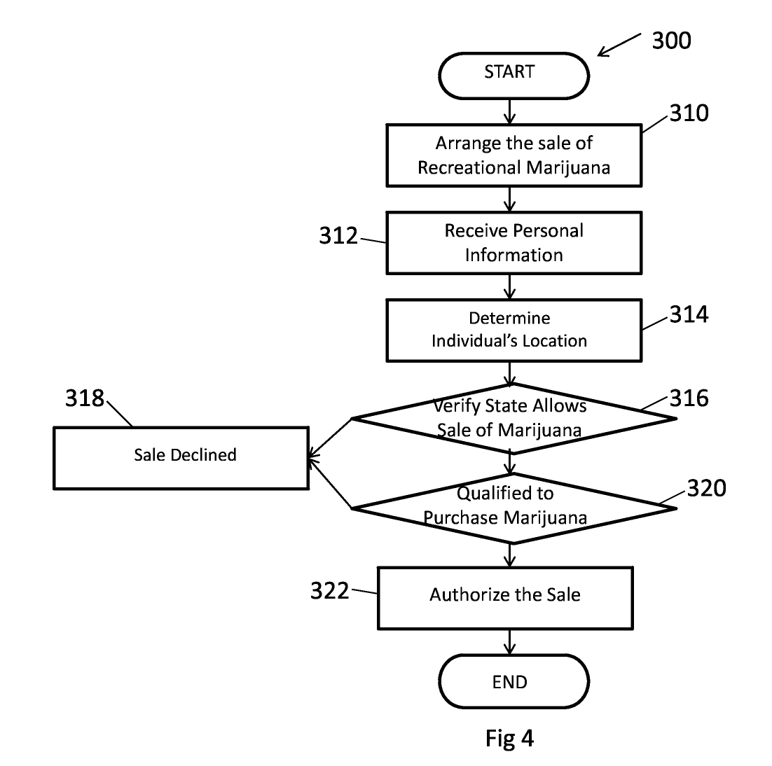

FIG. 4 illustrates a method, generally designated 300, for arranging for the sale of recreational marijuana and marijuana products over a network. The method 300 includes arranging for the sale, service, delivery and/or transportation of recreational marijuana and marijuana products over network block 310, which includes receiving an individual's personal information transmitted over the network from a user device, block 312. In at least one embodiment, receiving an individual's personal information includes manually entering the personal information, linking up with a social website (Facebook, Twitter, Linked In and the like); using an app that enables the user to take an image of an identifying document (state ID, drivers license, credit card, debit card, passport, birth certificate, and the like) to extract information and enter such information into a system, and the like.

Method 300 includes receiving an individual's location (either GPS-determined, API-determined or manually entered), block 314. Method 300 further includes verifying the individual is in a region/state which allows the sale of recreational marijuana and marijuana products based on such location, block 316; and determining the individual is legally qualified to purchase recreational marijuana and marijuana products based at least on the received personal information, block 320.

If method 300 determines the individual is not in a region/state which allows the sale of recreational marijuana and marijuana products and/or determines the individual is not legally qualified to purchase recreational marijuana and marijuana products based at least on the received personal information, sale is declined, block 318. If the method 300 verifies the individual is in a state that allows the sale of recreational marijuana and marijuana products based on such location and determines the individual is legally qualified to purchase recreational marijuana and marijuana products, the method 300 authorizes the sale of the recreational marijuana and marijuana products to the individual, block 322.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for arranging for the sale, service, delivery and/or transportation of recreational marijuana and marijuana products over a network, comprising:
receiving an individual's personal information transmitted over the network from a user device;
receiving an individual's location;
verifying the individual is in a state which allows the sale of recreational marijuana and marijuana products based on such location;
determining the individual is legally qualified to purchase recreational marijuana and marijuana products based at least on the received personal information; and
authorizing the sale, service, delivery and/or transportation of the recreational marijuana and marijuana products to the individual.

2. The method of claim 1 wherein the user device is selected from the group comprising a cell phone, a smart phone, a tablet, a laptop, a desktop computer, land line phone, cars, planes, trains, personal digital assistants, work stations, desktop computers, hard wired phone, personal computers, stand alone computers, tower computers, cash registers, POP device, smart card terminal, biometric scanner and the like.

3. The method of claim 1 wherein the individual's personal information includes the individual's birthdate.

4. The method of claim 1, wherein the individual's personal information comprises a recreational marijuana permit or other indication allowing the legal purchase of marijuana.

5. The method of claim 1, wherein the individual's personal information comprises biometric information.

6. The method of claim 1, wherein the network is selected from the group comprising an intranet, wired, wireless and/or cellular network.

7. A non-transitory computer-readable storage medium having stored there on computer-executable instructions that, in response to execution, cause a data transmission system to execute a method, the method comprising:
receiving an individual's personal information transmitted over the network from a user device;
receiving an individual's location;
verifying the individual is in a state which allows the sale of recreational marijuana and marijuana products based on such location;
determining the individual is legally qualified to purchase recreational marijuana and marijuana products based at least on the received personal information; and
authorizing the sale, service, delivery and/or transportation of the recreational marijuana and marijuana products to the individual.

8. The computer-readable storage medium of claim 7 wherein the user device is selected from the group comprising a cell phone, a smart phone, a tablet, a laptop, a desktop computer, land line phone, cars, planes, trains, personal digital assistants, work stations, desktop computers, hard wired phone, personal computers, stand alone computers, tower computers, cash registers, POP device, smart card terminal, biometric scanner and the like.

9. The computer-readable storage medium of claim 7 wherein the individual's personal information includes at least the individual's birthdate.

10. The computer-readable storage medium of claim 7, wherein the individual's personal information comprises a recreational marijuana permit or other indication allowing the legal purchase of marijuana.

11. The computer-readable storage medium of claim 7, wherein the individual's personal information comprises biometric information.

12. The computer-readable storage medium of claim 7, wherein the network is selected from the group comprising an intranet, wired, wireless and cellular network.

13. A system for arranging for the sale of recreational marijuana and marijuana products, the system comprising:
at least one server having computer-executable instructions thereon that, in response to execution, cause execution of a method;
at least one user device having a downloadable (or otherwise accessible or loadable) application operating thereon; and
at least one network enabling communication between the at least one processing unit and the at least one user device;
the method comprising:
determining an individual's location using the user device;
transmitting an individual's personal information and location over the network from the user device;
receiving the individual's personal information and location at the at least one processor transmitted over the network;
verifying the individual is in a state which allows the sale of recreational marijuana and marijuana products based on such location;
determining the individual is legally qualified to purchase recreational marijuana and marijuana products based at least on the received personal information; and
authorizing the sale of the recreational marijuana and marijuana products to the individual.

14. The system of claim 13 wherein the user device is selected from the group comprising a cell phone, a smart phone, a tablet, a laptop, a desktop computer, land line phone, cars, planes, trains, personal digital assistants, work stations, desktop computers, hard wired phone, personal computers, stand alone computers, tower computers, cash registers, POP device, smart card terminal, biometric scanner and the like.

15. The system of claim 13 wherein the individual's personal information includes at least the individual's birthdate.

16. The system of claim 15, wherein the individual's personal information comprises a recreational marijuana permit or other indication allowing the legal purchase of marijuana.

17. The system of claim 13, wherein the individual's personal information comprises biometric information.

18. The system of claim 13, wherein the network is selected from the group comprising an intranet, wired, wireless and cellular network.

19. The system of claim 13 wherein the at least one processing unit determines the individual is legally qualified to purchase recreational marijuana and marijuana products based at least on the received personal information; and authorizes the sale of the recreational marijuana and marijuana products to the individual.

20. The system of claim 13 wherein an indication authorizing the sale of the recreational marijuana and marijuana products to the individual is transmitted to at least one of the user device and a retailer/provider device.
